(19) United States
(12) Patent Application Publication
(10) Pub. No.: US 2006/0047625 A1
(43) Pub. Date: Mar. 2, 2006

(54) DBMS administration of secure stores

(75) Inventors: Min-Hank Ho, Newark, CA (US); Daniel ManHung Wong, Sacramento, CA (US); Thomas Keefe, Mill Valley, CA (US); Rama Vissapragada, Redwood City, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood City, CA (US)

(21) Appl. No.: 10/921,416

(22) Filed: Aug. 16, 2004

(51) Int. Cl. G06F 17/30

(52) U.S. Cl. 707/2

(57) ABSTRACT

Methods, systems, and machine-readable mediums are disclosed for administering secure stores using a database management system (DBMS). In one embodiment, the method comprises receiving, at a DBMS, a command to access a secure store. In response to the command, at least a portion of the contents are loaded into a memory structure.

### BACKGROUND OF THE INVENTION

Secure stores, such as Public Key Cryptography Standards (PKCS) SafeBags and Oracle Wallets, may be used to store sensitive information. By way of example, secure stores may be used to store Public Key Infrastructure (PKI) certificates, private keys, certificate revocation lists (CRLs), and other types of secret information. The secrecy of the information may be maintained by using various security mechanisms. At the lowest level, the security of a secure store may be protected by obfuscation. An additional level of security may be had by requiring a password to access the secure store. The password may be used to generate an encryption key, which in turn may be used to encrypt the contents of the secure store

Currently, secure stores are administered through graphical user interfaces (GUIs) or command line tools. These tools may be used for basic provisioning and administration of the secure stores. However, these tools do not provide a convenient way for users of a DBMS to access the secure stores.

### BRIEF SUMMARY OF THE INVENTION

Methods, systems, and machine-readable mediums are disclosed for administration of secure stores using a DBMS. In one embodiment, the method comprises receiving, at a DBMS, a command to access a secure store (e.g., a PKCS SafeBag or an Oracle Wallet). In some embodiments, the command may be a structured query language (SQL) command. In response to the command, the DBMS loads at least a portion of the contents of the secure store in a memory structure. For instance, the memory structure may be a virtual table. The DBMS may enable access to at least a subset of the memory structure contents by creating a fixed view of the contents.

The method may further comprise receiving a second command (e.g., an SQL command) at the DBMS to view a subset of the memory structure contents. In response to the second command, a fixed view of the memory structure contents may be displayed. Commands to alter the contents of the secure store may alternately or additionally be received by the DMBS. These commands may be SQL commands, such as insert, update, delete, or alter commands. The DBMS may alter the contents of the secure store in response to the received commands.

In another aspect, the method may additionally comprise receiving a second command at the DBMS to set a master encryption key. A new master key and a key identifier for the new master key are obtained at the DBMS. The new master key may be generated. Alternately, in some embodiments, a certificate identification may be received as part of the second command and the new master key may be obtained by retrieving a key value associated with the certificate identification from the secure store or another secure store. The new master key is encrypted and they are stored in either the secure store or a second secure store.

In another embodiment, a method is disclosed which comprises receiving, at a DBMS, a SQL command to alter the contents of a secure store. In response to the SQL command, the DBMS alters the secure store.

In a third embodiment, a DBMS system is disclosed. The DBMS system comprises a first communications interface configured to receive a command and a second communications interface to access a secure store. Logic is communicatively coupled with the first and second communications interface. The logic is configured to process a first set of commands to manipulate data in a database associated with the DBMS. The logic is further configured to process a second set of commands to access at least a portion of the contents in one or more secure stores using the second communications interface. In some aspects, the logic may also be configured to alter the contents of the one or more secure stores using the second communications interface.

### BRIEF DESCRIPTION OF THE DRAWINGS

Illustrative embodiments in accordance with the invention are illustrated in the drawings in which:

FIG. 1 is a block diagram of an exemplary computer network system that may use a DBMS to administer secure stores;

FIG. 2 is a block diagram of an exemplary computer system upon which a DBMS may be implemented;

FIG. 3 illustrates an exemplary embodiment of a system using a DBMS to manage secure stores;

FIG. 4 illustrates an exemplary secure store;

FIG. 5 is a flow diagram of a method for accessing a secure store using a DBMS according to one embodiment; and

FIG. 6 is a flow diagram illustrating an exemplary embodiment of setting a master key for encryption using a DBMS.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

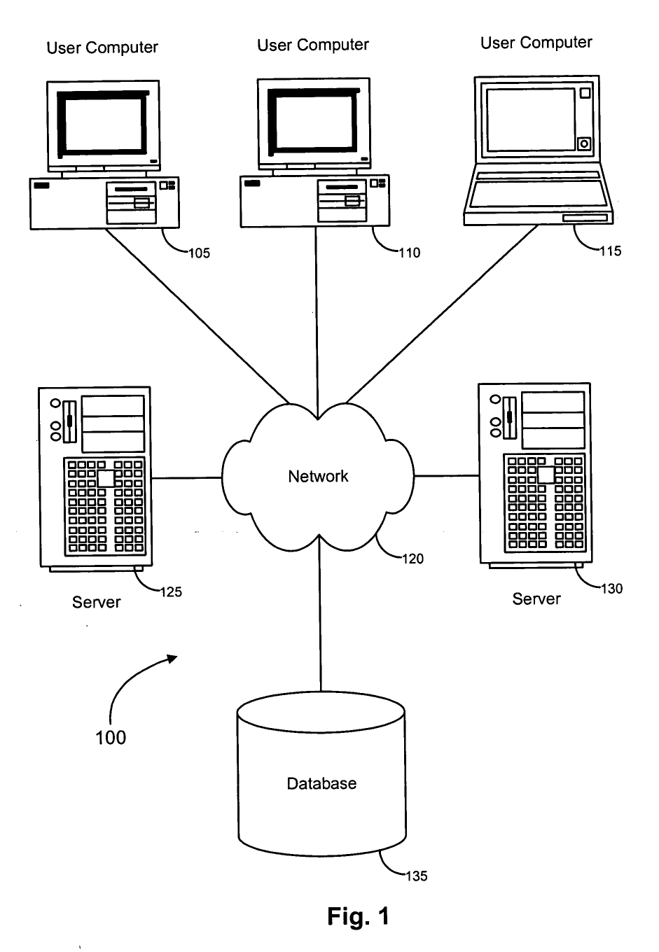

FIG. 1 illustrates a block diagram of a computer network system 100 that may use a DBMS to administer secure stores. The system 100 includes one or more user computers 105, 110, and 115. The user computers 105, 110, and 115 can be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 105, 110, 115 may also have any of a variety of applications, including for example, database client and/or server applications, and web browser applications. Alternatively, the user computers 105, 110, and 115 may be any other electronic device, such as a thin-client computer, Internet-enabled mobile telephone, and/or personal digital assistant, capable of communicating via a network (e.g., the network 120 described below) and/or displaying and navigating web pages or other types of electronic documents. Although the exemplary system 100 is shown with three user computers, any number of user computers may be supported.

In some embodiments, the system 100 may also include a network 120. The network may be any type of network familiar to those skilled in the art that can support data communications using any of a variety of commercially-available protocols, including without limitation TCP/IP, SNA, IPX, AppleTalk, and the like. Merely by way of example, the network 120 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server computers 125, 130. One server may be a web server 125, which may be used to process requests for web pages or other electronic documents from user computers 105, 110, and 120. The web server can be running an operating system including any of those discussed above, as well as any commercially-available server operating systems. The web server 125 can also run a variety of server applications, including HTTP servers, FTP servers, CGI servers, database servers, Java servers, and the like.

The system 100 may also include one or more file and or/application servers 130, which can, in addition to an operating system, include one or more applications accessible by a client running on one or more of the user computers 105, 110, 115. The server(s) 130 may be one or more general purpose computers capable of executing programs or scripts in response to the user computers 105, 110 and 115. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 130 may also include database management system (DBMS) servers, including without limitation those commercially available from Oracle, Microsoft, Sybase™, IBM™ and the like, which can process requests from database clients running on a user computer 105.

In some embodiments, an application server 130 may create web pages dynamically for displaying information. The web pages created by the web application server 130 may be forwarded to a user computer 105 via a web server 125. Similarly, the web server 125 can receive web page requests and/or input data from a user computer 105 and can forward the web page requests and/or input data to the web application server 130.

In further embodiments, the server 130 may function as a file server. Although for ease of description, FIG. 1 illustrates a separate web server 125 and file/application server 130, those skilled in the art will recognize that the functions described with respect to servers 125, 130 may be performed by a single server and/or a plurality of specialized servers, depending on implementation-specific needs and parameters.

The system 100 may also include a database 135. The database 135 may reside in a variety of locations. By way of example, database 135 may reside on a storage medium local to (and/or resident in) one or more of the computers 105, 110, 115, 125, 130. Alternatively, it may be remote from any or all of the computers 105, 110, 115, 125, 130, and in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, that is adapted to store, update, and retrieve data in response to SQL-formatted commands.

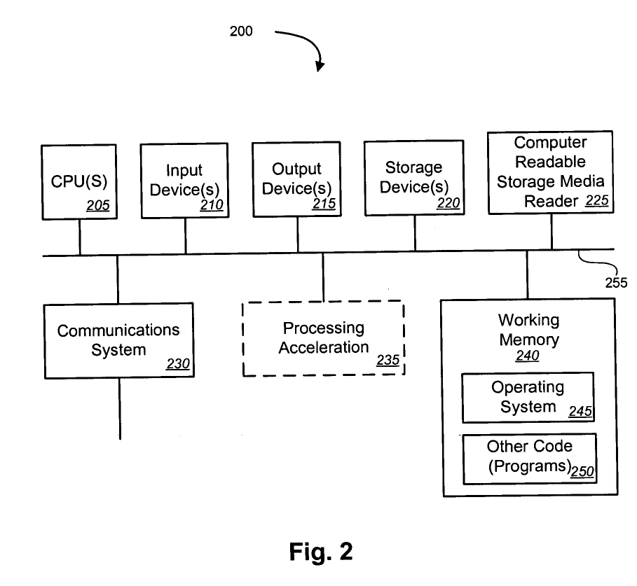

FIG. 2 illustrates one embodiment of a computer system 200 upon which a DBMS used to administer secure stores may be implemented. The computer system 200 is shown comprising hardware elements that may be electrically coupled via a bus 255. The hardware elements may include one or more central processing units (CPUs) 205; one or more input devices 210 (e.g., a mouse, a keyboard, etc.); and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above. In some embodiments, the computer system 200 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with a network and/or any other computer.

The computer system 200 may also comprise software elements, shown as being currently located within a working memory 240, including an operating system 245 and/or other code 150, such as an application program. It should be appreciate that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

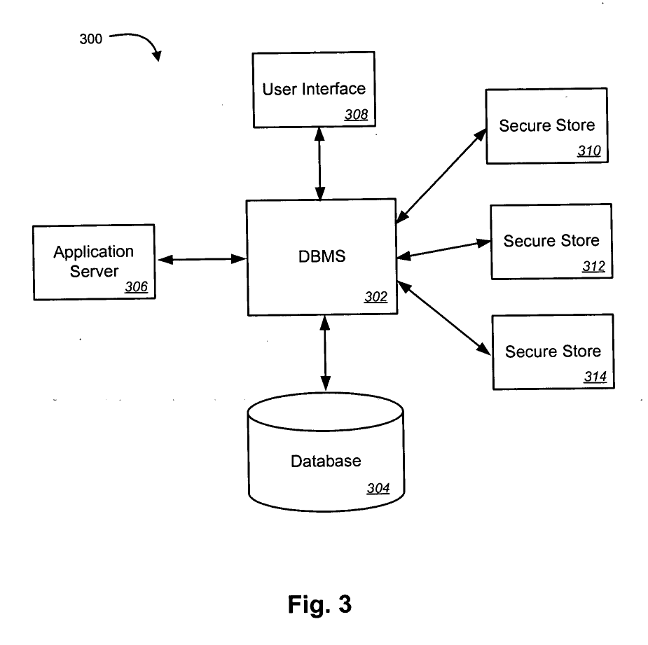

FIG. 3 illustrates an exemplary embodiment of a system that may use a DBMS 302 to manage secure stores. The system 300 includes a DBMS 302 communicatively coupled with a database 304. In one embodiment, the DBMS 302 may be a Relational DBMS (RDBMS) and the database 304 may be a relational database. The DBMS 302 may include logic (e.g., program code) that may be used to manage and manipulate data in database 304. The logic may be used process commands received at an interface to the DBMS 302. By way of example, the commands may be SQL commands and the logic in the DBMS 302 may include a SQL Engine to process the commands. The commands may be received from a variety of sources, such as an application server 306 or user interface 308 (e.g. command line interface or GUI interface).

As will be described in further detail below, some of the commands that may be processed by the DBMS 302 may include commands to access and manipulate the contents of one or more secure stores 310, 312, 314. Thus, the DBMS 302 may include an interface that may be communicatively coupled with secure stores 310, 312, 314. Secure stores 310, 312, 314 may be used to store sensitive information, such as PKI certificates, private keys, certificate revocations, and other types of secret information (e.g., user passwords, logon information, and other types of secret information, which may in some instances be stored as name/value pairs). The secure stores 310, 312, 314 may be any type of structure suitable for holding the sensitive information, such as a file or a memory structure. By way of example, the secure stores 310, 312, 314 may be PKCS SafeBags or Oracle Wallets. In some embodiments, each secure store 310, 312, 314 may be designated to hold certain types of information. For example a first secure store 310 may be used to hold PKI certificates while another secure store 314 may be used to hold private key information. In some instances, a secure store 310 may contain multiple secure stores of different types. It should be appreciated that additional or fewer secure stores 310, 312, 314 may be communicatively coupled with an interface of DBMS 302. Additionally, in some instances, a secure store 310 may contain multiple secure stores of different types.

In the configuration described above, different components were described as being communicatively coupled to other components. A communicative coupling is a coupling that allows communication between the components. This coupling may be by means of a bus, cable, network, wireless mechanism, program code call (e.g., modular or procedural call) or other mechanism that allows communication between the components. Thus, it should be appreciated that DBMS 302, database 304, application server 306, user interface 308, and secure stores 310, 312, 314 may reside on the same or different physical devices. Additionally, it should be appreciated that in alternate embodiments, the system described in FIG. 3 may contain additional or fewer components. For instances, one or more additional DBMS' may also be able to access one or more of the secure stores 310, 312, 314.

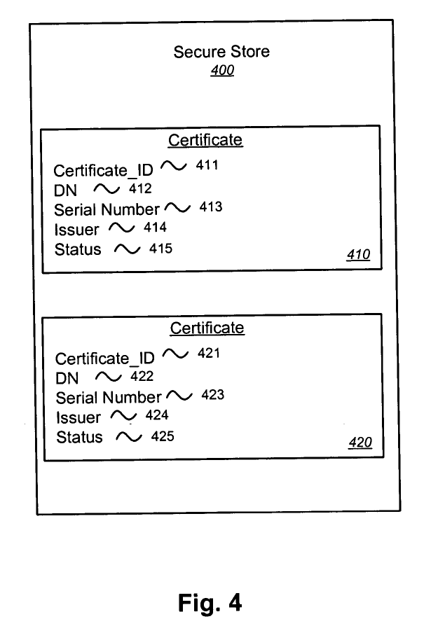

FIG. 4 illustrates the contents of one exemplary secure store 400 that may be used to hold one or more PKI certificates 410, 420. Each PKI certificate 410, 412 may include a certificate identification 411, 421, such as a text identifier that may be used to identify the certificate 410, 420. The certificates 410, 420 may also include a distinguished name 412, 422 and a serial number 413, 423. Other types of information that may be included in a certificate 410, 420 are the issuer 414, 424 (e.g., the distinguished name of the certificate authority that issued the certificate) and the status 415, 425 (e.g., available, in-use, used, etc.). In alternate embodiments, the certificates 410, 420 may contain information different than that illustrated in FIG. 4. Additionally, the secure store 400 may also contain content in addition to certificates 410, 420. For instances, the secure store 400 may also include key and password content..

Secure stores different than that illustrated in FIG. 4 may also be administered by a DBMS 302. For example, an additional secure store may be used to hold the key values associated with a certificate id 411 (e.g., the private key). In some instances, a third secure store may be used to hold both secure store 400 and the private key secure store. The third secure store may also be used to hold additional secure stores. As another example, a secure store may be a secret store (e.g., a PKCS SecretBag) containing other private information. It should be appreciated that many other types of secure stores may also be administered by DBMS 302.

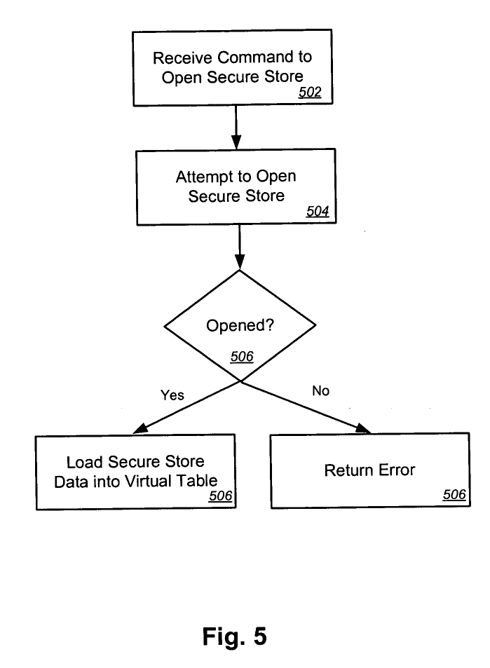

FIG. 5 illustrates an exemplary method that may be used by a DBMS to access a secure store. The method may begin by receiving 402 a command at a DBMS to open 502 or access a secure store. In some embodiments, the command may be a SQL command. For example, the command may take the format: “alter system set secure_store_id open”. The command may also be in another format. In some instances, the secure store may require a password. In those instances, the password may be included as part of the command, such as by adding an “authenticated by password” to the end of the command. To protect the security of the password, the password may be masked in audit trails.

After the DBMS receives 502 the command to open the secure store, the DBMS may then attempt to open 504 the secure store. The DBMS may open 504 the secure store using the appropriate interface to the secure store. In one embodiment, the interface may be an interface such as that described by the PKCS #11 standard. The attempt to open the secure store may fail for a variety of reasons, such as an invalid password or the secure store cannot be located. If the attempt fails, an error may be returned 506 to the user or application. Additional details on the reason of the failure may be provided with the returned error.

If the secure store can be opened 506, the contents of the secure store may be loaded 506 by the DBMS into a memory structure, such as a virtual table. In some embodiments, the DBMS may go through a translator which translates the contents to a format recognizable by the DBMS. The DBMS may not load all of the contents of the secure store into the memory structure. For example, private keys may not be loaded.

To protect sensitive data, the DBMS may limit the data in the memory structure that may be viewed by a user. In one embodiment, a fixed view may be provided by the DBMS to view the authorized content. The user may view the designated contents of a secure store by issuing commands to the DBMS to access the information. For example, the command may be an SQL select command that operates on the fixed view. In response to the command, the DBMS may display or return the requested contents. Before returning the contents, the DBMS may verify the requesting user has privileges to view the information.

The DBMS may also process commands to alter the contents of secure stores. By way of example, the contents of a secure store may be altered by issuing SQL commands, such as insert, update, and delete. The DBMS may respond to these commands by altering the contents of the secure store in accordance with the received command. It should be appreciated that the DBMS may also process other types of commands that may assist in the administration of a secure store, such as commands to create a secure store or commands to delete or remove the secure store from the memory structure.

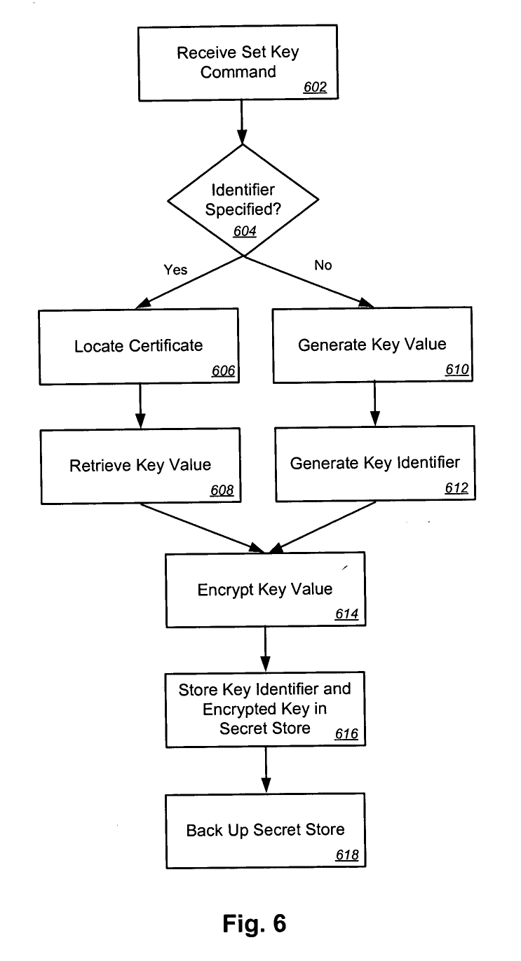

Some of the commands that may be issued to a DBMS may not explicitly request that the contents of a secure store be altered, but execution of the command may result in changes being made to a secure store. One such command may be a command to set a new master key used for encryption. FIG. 6 illustrates an exemplary method that may be used by a DBMS to set a new master key.

The method may begin by the DBMS receiving 602 a command (e.g., an SQL command) to set a master key value or other key value. Merely by way of example, the command may take the format “alter system set [certificate_id] [authenticated by password]”, where the brackets indicate optional parameters. Thus, in some instances, the DBMS may generate or request the generation of the master key and in other instances, the user may specify a certificate having a private key value that may be used for the master key.

If an identifier is specified 604, the DBMS may locate 606 the certificate. This may be done by accessing a secure store holding certificates to verify the certificate exists and the status of the certificate. If the status indicates the certificate may be used, the DBMS may alter the status to indicate the certificate is now in use. The DBMS may additionally change the status of a certificate that was previously in use to “used” or other appropriate status. After the certificate has been located 606 and the status verified, a key value associated with the certificate may be retrieved 608 and used as the master key value. For example, this may be accomplished by the DBMS accessing the secure store or a second secure store (e.g., a secure store containing private keys) to obtain the private key value associated with the certificate. Processing may then continue at block 614, which will be described below.

If a certificate identification is not specified 604, the method may continue by generating 610 a new master key value. In some instances, the DBMS may call a random number generator to generate a key value of appropriate length. The DBMS may also generate 612 a key identifier. The key identifier generated may be a universally unique identifier. The method may then continue with block 614.

At block 614, the master key value is encrypted 614 for security. The DBMS may perform the encryption or may request the encryption from an encryption service. The key identifier, which in the case of a key associated with a certificate may be the certificate identification, and the encrypted key may then be stored 616 secure store, such as a PKCS SecretStore or other type of secure store for secret information. The secret store may be a part of the secure store holding certificate and/or private key contents or it may be a third secure store. In some cases, the secret store may not yet exist or may not be initialized, and thus, the DBMS may first create and/or initialize the secret store. After the information has been stored 618, the DBMS may initiate a backup 618 of the secure store to protect the data. The new master key value (or other requested key value) may be used by the DBMS to encrypt data or other purpose. Thus, it should be appreciated that the contents of one or more secure stores were altered by the DBMS.

An exemplary usage of a DBMS to administer a secure store will now be discussed. The user may first request that the DBMS open a secure store. As described in FIG. 5, the DBMS may respond to the command by opening the secure store and loading into a memory structure, such as a virtual table. The user may then access the information by issuing commands, such as select commands. For instance, the user may choose to view information on PKI certificates. After viewing the information, the user may request the DBMS to set a key value using a specified certificate. The DBMS may then set the key value as described in FIG. 6.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method comprising:
receiving, at a database management system (DBMS), a command to access a secure store; and
in response to the command, loading at least a portion of the contents of the secure store in a memory structure.

2. The method of claim 1, further comprising creating a fixed view to enable access to at least a subset of the memory structure contents.

3. The method of claim 1, wherein the command includes a password, the method further comprising verifying the password is associated with the secure store.

4. The method of claim 1, wherein loading at least a portion of the contents comprises loading the portion of the contents into a virtual table.

5. The method of claim 1, wherein the command is a structured query language (SQL) command.

6. The method of claim 1, further comprising receiving, at the DBMS, a second command to view a subset of the memory structure contents.

7. The method of claim 6, wherein the second command is a structured query language (SQL) select command.

8. The method of claim 6, further comprising, in response to the second command, displaying a fixed view of the memory structure contents.

9. The method of claim 1, further comprising receiving, at the DBMS, a second command to alter the contents of the secure store.

10. The method of claim 9, further comprising, in response to the second command, altering, with the DBMS, the contents of the secure store in accordance with the second command.

11. The method of claim 9, wherein the second command is a structured query language (SQL) command.

12. The method of claim 11, wherein the SQL command is one of an insert, update, and SQL delete.

13. The method of claim 11, wherein the SQL command is an alter command.

14. The method of claim 1, further comprising:
receiving, at the DMBS, a second command to set a master encryption key;
obtaining at the DBMS, a new master key;
obtaining, at the DBMS, a key identifier for the new master key;
encrypting the new master key; and
storing the key identifier and the encrypted new master key in one of the secure store or a second secure store.

15. The method of claim 14, wherein the second command includes a certificate identification and wherein obtaining a new master key comprises retrieving, with the DBMS, a key value associated with the certificate identification from one of the secure store or a third secure store.

16. The method of claim 15, wherein obtaining a key identifier comprises using the certificate identification as the key identifier.

17. The method of claim 14, wherein obtaining a new master key comprises generating the new master key.

18. The method of claim 1, wherein the secure store is a Public Key Cryptography Standard (PKCS) SafeBag.

19. The method of claim 1, wherein the secure store is an Oracle Wallet.

20. A method comprising:
receiving, at a database management system (DBMS), a structured query language (SQL) command to alter contents of a secure store; and
in response to the SQL command, altering the secure store.

21. The method of claim 20, wherein the command is one of an insert, update, and delete command.

22. The method of claim 20, wherein the command is an alter command.

23. The method of claim 20, wherein the command is a command to set a new master key to encrypt data, and wherein altering the secure store comprises storing the new master key and a key identifier in the secure store.

24. A Database Management System (DBMS) comprising:
a first communications interface configured to receive commands;
a second communications interface to access a secure store; and
logic, communicatively coupled with the first and second communications interface, configured to process a first set of commands to manipulate data in a database associated with the DBMS and to process a second set of commands to access at least a portion of the contents in one or more secure stores using the second communications interface.

25. The method of claim 24, wherein the logic is further configured in response to a command, to alter the contents of the one or more secure stores using the second communications interface.

26. The DBMS of claim 24, wherein the second communications interface is configured to access a Public Key Cryptography Standards (PKCS) SafeBag.

27. The DBMS of claim 24, wherein the logic comprises a SQL Engine.

28. The DBMS of claim 24, wherein the DBMS is a relational DBMS.

29. At least one machine-readable medium, having stored thereon sequences of instructions, which, when executed by a machine cause the machine to:
receive, at a database management system (DBMS), a command to access a secure store; and
in response to the command, load at least a portion of the contents of the secure store in a memory structure.

30. At least one machine-readable medium, having stored thereon sequences of instructions, which, when executed by a machine cause the machine to:
receive, at a database management system (DBMS), a structured query language (SQL) command to alter contents of a secure store; and
in response to the SQL command, alter the secure store.

31. A method comprising the steps of:
a step for receiving, at a database management system (DBMS), a command to access a secure store; and
a step for loading at least a portion of the contents of the secure store in a memory structure.
